(19) United States
(12) Patent Application Publication
(10) Pub. No.: US 2008/0004024 A1
(43) Pub. Date: Jan. 3, 2008

(54) Managing subscriber connections between at least two types of wireless networks

(75) Inventors: Anuj Puri, Santa Clara, CA (US); Bertrand Hochwald, Santa Clara, CA (US)

Correspondence Address: Beceem Communications, Inc., P.O. Box 6585, Santa Clara, CA, 95056-6585, US

(73) Assignee: Beceem Communications, Inc.

(21) Appl. No.: 11/823,296

(22) Filed: Jun. 27, 2007

Related U.S. Application Data
(60) Provisional application No. 60/817,526, filed on Jun. 28, 2006.

(51) Int. Cl. H04Q 7/20

(52) U.S. Cl. 455/436

(57) ABSTRACT

Methods a wireless system managing subscriber handoff from a first type wireless network to a second type of wireless network are disclosed. The method includes the subscriber communicating with a first type of wireless network. The subscriber negotiates a mode with the first type of wireless network establishing a period of time in which the first type of wireless network does not wirelessly transmit data to the subscriber. The subscriber monitors communication with a second type of wireless network during the established period of time.

### CROSS-REFERENCE TO RELATED APPLICATION

This application claims the benefit of U.S. Provisional Application Patent Application No. 60/817,526, filed on Jun. 28, 2006, which is incorporated by reference in its entirety herein.

### FIELD OF THE DESCRIBED EMBODIMENTS

The invention relates generally to wireless communications. More particularly, the invention relates to managing subscriber connections between at least two types of wireless networks.

### BACKGROUND OF THE INVENTION

Wireless communication technologies are rapidly evolving and being deployed. In some situations, it is possible to obtain wireless connections to multiple (for example, 3G, WiMAX and WiFi) wireless networks at a given location. However, at the given location, one of the types of networks may provide a better wireless connection as determined by a better quality of service (QoS) or signal to noise ratio (SNR). Additionally, one type of network may provide better support of a particular type of data traffic.

Generally, a subscriber device of a wireless network user can only communicate with one type of wireless network at a time. Therefore, the user is not able to take advantage of a better connection provided by a wireless network that the subscriber device of the user is not connected to. Additionally, the subscriber unit cannot adaptively select which wireless network to connect to, based on the type of data being transmitted or other metrics.

A subscriber may be able to simultaneously communicate with multiple networks if the subscriber constantly powers electronic circuitry required to support the multiple networks. Additionally, the multiple networks typically must operate over separate communication channels to minimize interference between the multiple networks. Furthermore, subscribers are typically battery powered units, and it is undesirable to provide continuous power to circuitry required to simultaneously support multiple networks. Without powering multiple network support circuitry, if the subscriber unit changes the type of wireless network it is connected to, the communication to the first wireless network must be halted for a period of time while the subscriber initiates the connection to the second type of wireless network.

It is desirable for a low-power subscriber unit to monitor existence of multiple types of wireless networks and select the most desirable of the wireless network. It is additionally desirable that communications with the networks be minimally impacted while monitoring for network availability and switching from one wireless network to another wireless network.

### SUMMARY OF THE INVENTION

An embodiment includes a method of a subscriber searching for available wireless networks. The method includes the subscriber communicating with a first type of wireless network. The subscriber negotiates a mode with the first type of wireless network establishing a period of time in which the first type of wireless network does not wirelessly transmit data to the subscriber. The subscriber monitors communication with a second type of wireless network during the established period of time.

Another embodiment includes a method of a wireless system managing subscriber handoff from a first type wireless network to a second type of wireless network. The method includes a first base station of a first type of wireless network communicating with a subscriber. The first base station negotiates a mode with the subscriber establishing a period of time in which the first base station will not wirelessly transmit data to the subscriber. The subscriber monitors communication with a second base station of a second type of wireless network during the established period of time.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows an example of cells of a first type of wireless network in which hot spots of a second type of wireless network are located within some of the cells.

FIG. 2 shows a subscriber simultaneously receiving transmission signals from two different types of networks.

FIG. 3 is a flow chart showing steps of one example of a method of a subscriber unit managing wireless hand-off from a first type of wireless network to a second type of wireless network.

FIG. 4 is a flow chart that includes steps of a method of a wireless system managing subscriber handoff from a first type wireless network to a second type of wireless network

FIG. 5 shows an example of multiple types of wireless networks that includes 802.16 base stations and an 802.11 access point.

### DETAILED DESCRIPTION

Method and apparatuses for handoff between wireless network types are disclosed. Embodiments of the methods and apparatuses provide simultaneous wireless communication with a first wireless network type while monitoring the availability of other wireless network types.

The following description includes first and second types of wireless networks. The network types can include WiMax (802.16) and WiFi (802.11) wireless networks. However the embodiments described are not limited to these types of wireless networks. Additionally, the descriptions show two network types. However, the embodiments described are not limited to only two types of wireless networks. The described wireless networks include base stations (with cells) and access points (with hot spots). Base stations (cells) are sometimes identified with 802.16 wireless networks, and access points (hot spots) are sometimes identified with 802.11 wireless networks. However, the embodiments described are not limited by these conventions.

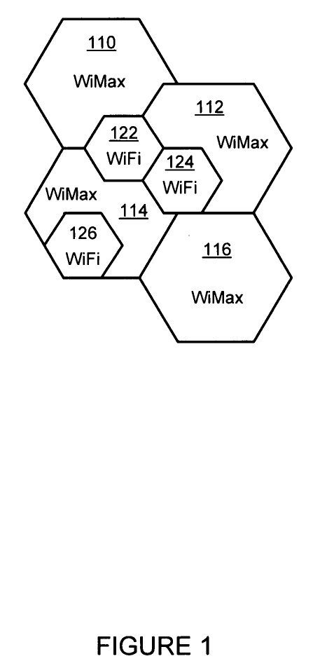

FIG. 1 shows an example of cells 110, 112, 114, 116 of a first type of wireless network in which hot spots 122, 124, 126 of a second type of wireless network are located within some of the cells 110, 112, 114. Examples of an implementation of the cells 110, 112, 114, 116 of the first type of wireless network include wireless cells 110, 112, 114 formed by an 802.16 (WiMax) wireless network. Exemplary hot spots of the second type of wireless network include hot spots formed by an 802.11 access points.

The two different types of networks can have different features that can make one or the other more or less attractive to a subscriber device. For example, it may be more expensive for a subscriber to connect and remain connected to an 802.16 wireless network than for the subscriber to connect and remain connected to an 802.11 wireless network. However, the 802.11 connection may provide inferior performance, or not provide the subscriber with a desired level of mobility. The subscriber could, for example, maintain an 802.16 wireless connection if the desired level of wireless performance requires it, and then switch over to an 802.11 wireless connection if the subscriber has access to an 802.11 access point, and the subscriber does not require a level of performance as provided by the 802.16 wireless connection.

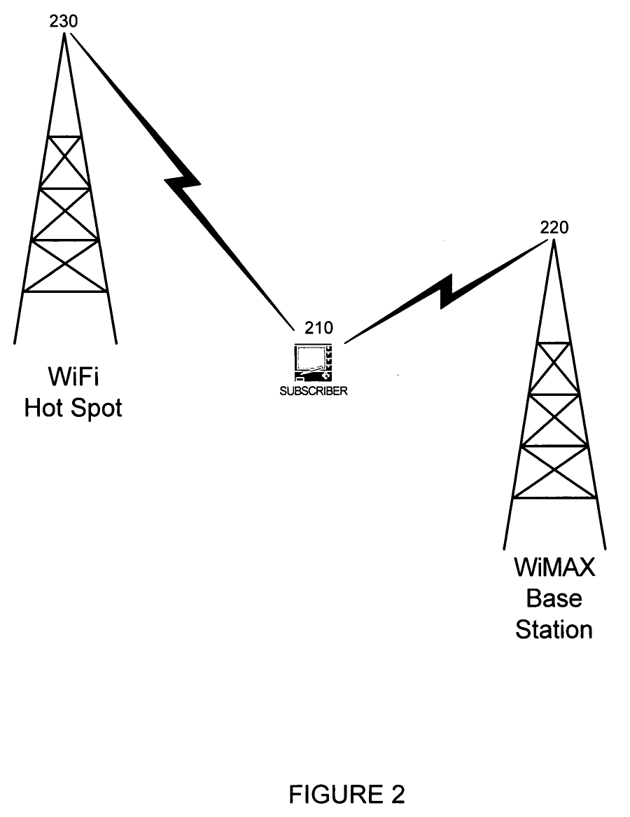

FIG. 2 shows an example of a subscriber 210 that is simultaneously able to wirelessly connect to two different types of networks 220, 230. As will be described, the subscriber 210 can roam from one network to the other while being connected to one network at a time. Alternatively, the subscriber can simultaneously maintain wireless connections between both types of networks 220, 230. That is, the subscriber 210 can communicate with one type of wireless network for some types of data, and with another type of wireless network for other types of data.

The first type of wireless network can include an 802.16 wireless network and the second type of wireless network can include an 802.11 wireless network. For the descriptions, alternatively, the first type of wireless network can include an 802.11 wireless network and the second type of wireless network can include an 802.16 wireless network.

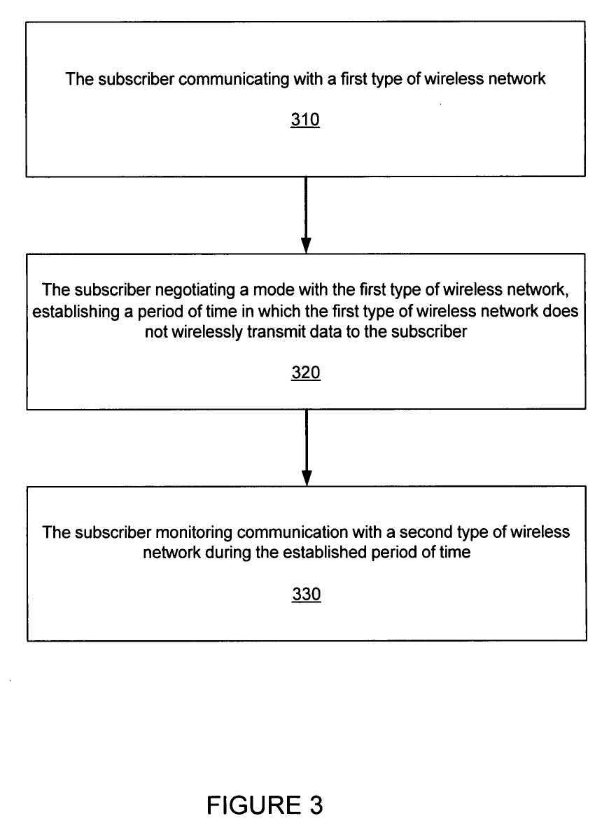

FIG. 3 is a flow chart showing steps of one example of a method of a subscriber searching for availability of multiple wireless networks. A first step 310 includes the subscriber communicating with a first type of wireless network. A second step 320 includes the subscriber negotiating a mode with the first type of wireless network, establishing a period of time in which the first type of wireless network does not wirelessly transmit data to the subscriber. A third step 330 includes the subscriber monitoring communication with a second type of wireless network during the established period of time.

During the negotiated and established period of time, the subscriber can search for the second type of wireless network. That is, during the negotiated mode, the subscriber searches for the second type of wireless network. An embodiment includes the subscriber searching for the second type of wireless network non-periodically. Embodiments of the second network transmit periodic signals. That is, for example, and 802.11 (WiFi) networks periodically transmits beacons. To ensure that the subscriber can find the periodic signal of the second network while not knowing the period, the subscriber non-periodically searches for the periodic signal of the second type of wireless network.

Examples of the negotiated mode include a sleep mode, a scan mode, and an idle mode. The sleep mode is used when the subscriber does not have data to transmit and may negotiate intervals of time during which the subscriber can power down to save battery life. When connected to the first wireless network, the subscriber uses the scan mode to search for base stations of the first wireless network. During the idle mode, the subscriber may power down for a longer period of time.

In the sleep mode, the subscriber “sleeps” for an interval of time, called a “sleep window”, then the subscriber wakes up for what is called a “listen window” to check if there is traffic waiting for it. After this the subscriber again goes to sleep for a sleep window and so on. The sleep windows may get larger until it reaches a final window size. In one embodiment, the subscriber negotiates to enter the sleep mode with the first wireless network so that the subscriber can search for the access points of the second wireless network during the sleep window. The first wireless network buffers the data for the subscriber during the sleep window. During the sleep mode, the subscriber is able to search for the access points of the second wireless network during the sleep windows, and afterwards reconnect with the first wireless network to get the buffered data.

In another embodiment, the subscriber negotiates an initial sleep window and a final sleep window, wherein the initial sleep window and the final sleep window have a common length. For this embodiment, the sleep window sizes are the same since the subscriber may only need a constant amount of time during each sleep window to search for the second type of wireless network.

When the negotiated mode is the scan mode, the first type of wireless network can initiate the negotiation by requesting the subscriber to scan for specific access points of the second type of wireless network. The first type of network can provide information about the access points of the second type of network to the subscriber. After having performed the scan, the subscriber can report information about the second type of wireless network obtained by the subscriber during a scan of the second type of network to the base station of the first type of wireless network using methods and protocols specific to the first network. Based on this information, the first type of wireless network can request the subscriber to handoff to a specific access point of the second type of wireless network.

Initiation of the negotiation between the subscriber and a base station of one of the types of networks can be conditioned by one of several things. A first condition includes the subscriber comparing conditions of the first wireless network to several predetermined criteria. Examples of predetermined criteria include latency threshold, QoS threshold, a jitter threshold, an error rate threshold, a data throughput threshold, an SINR threshold, a CINR threshold, a quantity of transmission data threshold, a cost of service threshold.

The subscriber, for example, can establish that it has a wireless connection with the first type of wireless network having a quality above a threshold, and therefore, maintain the wireless connection with the first type of wireless network. However, if the quality of the wireless connection to the first type of wireless network is below a threshold, the subscriber can negotiate a search mode (for example, one of the previously described modes) with the first type of wireless network to establish a wireless connection with the second type of wireless network.

The subscriber can initiate and maintain connections with the different types of wireless network based on a velocity of the subscriber relative to the base stations and/or access points. More specifically, the subscriber (or base station) can estimate a velocity of the subscriber. Based on the velocity, the subscriber (or base station) can initiate the negotiation for a wireless connection with a different type of wireless network. That is, for example, the subscriber can wirelessly connect to the first type of wireless network if the velocity is greater than a threshold value, and the subscriber can wirelessly connect to the second type of wireless network if the velocity is less than the threshold.

The subscriber can also initiate the negotiation of the mode if the subscriber determines conditions of data traffic to meet at least one of several predetermined criteria. That is, certain wireless networks are more conducive to wireless communication with subscribers for certain types of data than other wireless networks. For example, the first wireless network may only support data rates that are lower than the second wireless network. The second wireless network may be able to support high data rates at low cost to the subscriber. In this case, when the subscriber has large amount of data to transfer, the subscriber may use the second network. But the first wireless network may handle traffic that requires QoS more effectively than the second network. In this case, when the subscriber has traffic that requires QoS features, such as VoIP traffic, the subscriber may use the first network. Similarly, traffic that is being broadcast or multicast from the first network maybe more effectively received by the subscriber, from the first wireless network.

The subscriber can receive information about the second type of network from the base station of the first type of wireless network. The information received about the second type of network can include, for example, locations of access points of the second type of network, channel information of the second type of network, data rate of the second type of network, cost of the second type of network, a service provider of the second type of network, security of the second type of network, preamble identification of the second type of network, and/or authentication mechanism of the second type of network.

One method in which the subscriber can obtain information about the second type of wireless network includes the first type of wireless network directly informing the subscriber. For example, the subscriber can receive the information about the second type of network within messages transmitted according to a protocol of the first type of network. More specifically, if the first type of wireless network is an 802.16 wireless network, the 802.16 wireless network can provide the subscriber with information about the second type of wireless network through an 802.16 MOB-NBR-ADV message. The 802.16 MOB-NBR-ADV message is part of the 802.16 protocol to support handoff between base stations supporting 802.16. The message contains information about other 802.16 base stations such as the Preamble Id of the other 802.16 base stations, operating channels of other 802.16 base stations. To permit handoffs between an 802.16 network and 802.11 network, the MOB-NBR-ADV message may contain information about the access points of the 802.11 network. This information may include the operating channel of the access point, type of access point, service provider of the 802.11 wireless network, and additional information as well.

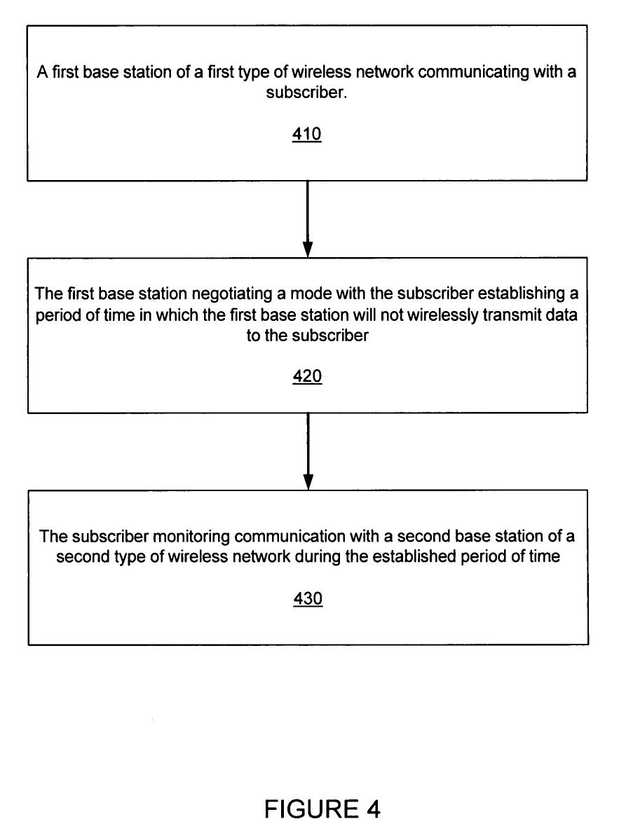

FIG. 4 is a flow chart that includes steps of an example of a method of a wireless system managing subscriber handoff from a first type wireless network to a second type of wireless network. A first step 410 includes a first base station of a first type of wireless network communicating with a subscriber. A second step 420 includes the first base station negotiating a mode with the subscriber establishing a period of time in which the first base station will not wirelessly transmit data to the subscriber. A third step 430 includes the subscriber monitoring communication with a second base station of a second type of wireless network during the established period of time.

As previously described, the subscriber can search for the second type of wireless network during the established period of time, which can correspond with the negotiated mode.

An embodiment of the system includes the first base station transferring context information to the second base station. The context information can include information about the subscriber and the subscriber connection.

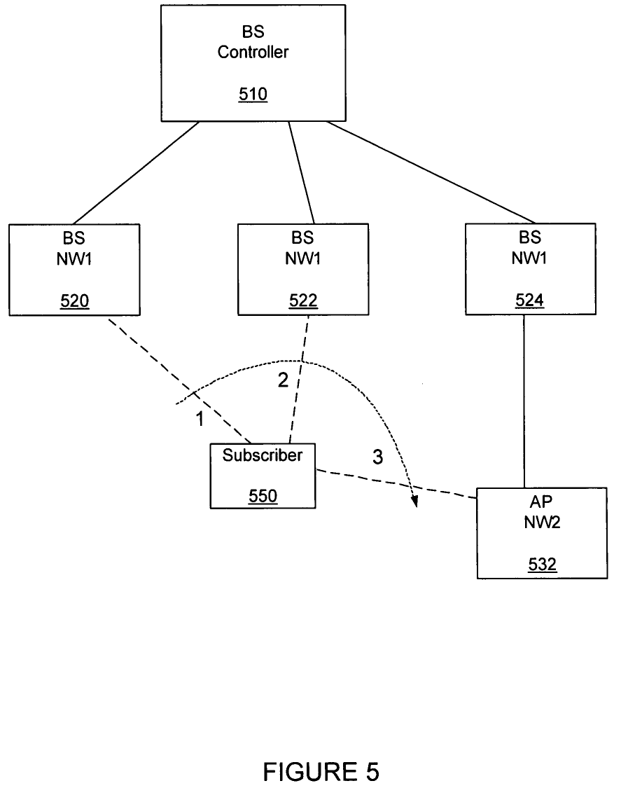

FIG. 5 shows an example of multiple types of networks that include, for example, 802.16 base stations 520, 522, 524 interfaced with an 802.11 hot spot 532. That is, the first type of wireless network can include multiple 802.16 base stations 520, 522, 524, and the second type of network can include one or more 802.11 hot spots (such as hot spot 532). In one embodiment, at least one of the 802.16 base stations (as shown, base station 524) can be interfaced (wired or wirelessly) with an 802.11 hot spot 532, wherein the second type of wireless network is the 802.11 network. Based on this configuration, for example, the first type of wireless network (802.16) can redirect packets for the subscriber 550 to a second base station (802.11 hot spot) of the first network, wherein the base station 524 of the first network services the base station (access point 532) of the second network. In addition to redirecting data, the first type of wireless network can aid the second type of network in things, such as, authenticating the subscriber 550. As shown, a base station controller 510 can direct the activities of the base stations 520, 522, 524 of the first type of wireless network. Because one of the base stations (524) is interfaced with the access point 532 of the second type of network, the base station controller 510 can maintain some control over the access point 532 through the base station 524.

As shown, the subscriber 550 can roam as shown (1 to 2 to 3) in which the subscriber roams between base stations 520, 522 of the first type of wireless network, and then to the access point 532 of the second type of wireless network.

Embodiments include the subscriber maintaining communication with multiple types of networks simultaneously. The type of data communication between the subscriber and the different types of networks can be classified differently. For example, an embodiment includes the subscriber maintaining communication with the first base station of the first type of wireless network for at least one specified type of data communication, and the subscriber simultaneously maintaining communication with the second base station of the second type of wireless network for at least one other specified type of data communication.

The classification between specified types of data communication can be differentiated by a level of quality of service (QoS). Specific examples include the specified type of data communications including, for example, voice data, broadcast or multi-cast data.

Although specific embodiments of the invention have been described and illustrated, the invention is not to be limited to the specific forms or arrangements of parts so described and illustrated. The invention is limited only by the appended claims.

What is claimed:

1. A method of a subscriber searching for available multiple types of wireless networks, comprising:
the subscriber communicating with a first type of wireless network;
the subscriber negotiating a mode with the first type of wireless network establishing a period of time in which the first type of wireless network does not wirelessly transmit data to the subscriber;
the subscriber monitoring communication with a second type of wireless network during the established period of time.

2. The method of claim 1, further comprising the subscriber searching for the second type of wireless network during the established period of time.

3. The method of claim 1, further comprising the subscriber searching for the second type of wireless network during the negotiated mode.

4. The method of claim 3, wherein the subscriber searching for the second type of wireless network occurs a periodically.

5. The method of claim 1, wherein the negotiated mode comprises at least one of a sleep mode, a scan mode, an idle mode.

6. The method of claim 1, wherein the negotiated mode comprises a sleep mode, and the method further comprises the subscriber negotiating an initial sleep window and a final sleep window.

7. The method of claim 1, wherein the negotiated mode comprises a sleep mode, and the method further comprises the subscriber selecting an initial sleep window and a final sleep window having a common length.

8. The method of claim 1, wherein the negotiated mode comprises a scan mode, and the method further comprises the first type of wireless network initiating the negotiation by requesting the subscriber to scan for specific access points of the second type of wireless network.

9. The method of claim 1, wherein the negotiated mode comprises a scan mode, and the method further comprises the subscriber reporting information to the first network about the second type of wireless network obtained by the subscriber during a scan of the second type of network.

10. The method of claim 1, further comprising the subscriber initiating the negotiating of the mode if the subscriber determines conditions of the first wireless network to meet at least one of a first set of predetermined criteria.

11. The method of claim 1, further comprising the subscriber initiating the negotiating of the mode if the subscriber determines conditions of data traffic to meet at least one of a second set of predetermined criteria.

12. The method of claim 11, wherein the second set of predetermined criteria comprises data connection QoS attributes, wherein the QoS attributes comprise at least one of latency, jitter, data rate, packet loss, cost of service of the data connection, connection type, wherein connection type comprises at least one of multicast traffic, broadcast traffic.

13. The method of claim 1, further comprising the subscriber initiating the negotiating of the mode if the subscriber determines conditions of the second type of network to meet at least one of a second set of predetermined criteria.

14. The method of claim 13, wherein the second set of predetermined criteria comprises at least one of SINR, CINR, cost of service, service provider, data throughput, QoS features, quantity of data transmission, error rate.

15. The method of claim 13, further comprising the first type of wireless network informing the subscriber of the conditions of the second type of network.

16. The method of claim 10, where in the set of predetermined criteria comprises at least one of a latency threshold, QoS threshold, a jitter threshold, an error rate threshold, a data throughput threshold, an SINR threshold, a CINR threshold, a quantity of transmission data threshold, a cost of service threshold.

17. The method of claim 1, further comprising the subscriber receiving information about the second type of network from the base station.

18. The method of claim 17, wherein the information received about the second type of network comprises at least one of locations of access points of the second type of network, channel information of the second type of network, data rate of the second type of network, cost of the second type of network, a service provider of the second type of network, security of the second type of network, preamble identification of the second type of network, authentication mechanism of the second type of network.

19. The method of claim 17, wherein the subscriber receives the information about the second type of network within messages transmitted according to a protocol of the first type of network.

20. The method of claim 19, wherein the messages comprises an 802.16 MOB-NBR-ADV message.

21. The method of claim 1, further comprising:
the subscriber initiating the negotiation of the mode if the wireless connection is below the threshold.

22. The method of claim 1, further comprising:
estimating a velocity of the subscriber;
initiating the negotiation based on velocity of the subscriber.

23. The method of claim 22, further comprising the subscriber wirelessly connecting to the first type of wireless network if the velocity is greater than a threshold value, and the subscriber wirelessly connecting to the second type of wireless network if the velocity is less than the threshold.

24. The method of claim 1, wherein the first type of wireless network comprises an 802.16 wireless network and the second type of wireless network comprises an 802.11 wireless network.

25. The method of claim 1, wherein the first type of wireless network comprises an 802.11 wireless network and the second type of wireless network comprises an 802.16 wireless network.

26. A method of a wireless system managing subscriber handoff from a first type wireless network to a second type of wireless network, comprising:
a first base station of a first type of wireless network communicating with a subscriber;
the first base station negotiating a mode with the subscriber establishing a period of time in which the first base station will not wirelessly transmit data to the subscriber;
the subscriber monitoring communication with a second base station of a second type of wireless network during the established period of time.

27. The method of claim 26, further comprising the subscriber searching for the second type of wireless network during the established period of time.

28. The method of claim 26, further comprising the subscriber searching for the second type of wireless network during the negotiated mode.

29. The method of claim 26, further comprising the first base station transferring context information to the second base station.

30. The method of claim 29, wherein the context information comprises information about the subscriber and the subscriber connection.

31. The method of claim 26, further comprising the first type of wireless network aiding the second type of network in authenticating the subscriber.

32. The method of claim 26, further comprising the first type of wireless network redirecting packets for the subscriber to a second base station of the first network, wherein the second base station of the first network services the second base station of the second network.

33. The method of claim 26, further comprising the subscriber maintaining communication with the first base station of the first type of wireless network for at least one specified type of data communication, and the subscriber simultaneously maintaining communication with the second base station of the second type of wireless network for at least one other specified type of data communication.

34. The method of claim 33, wherein the specified type of data communication and the other specified type of data communication are differentiated by a level of quality of service (QoS).

35. The method of claim 33, wherein the specified type of data communications comprises at least voice data.

36. The method of claim 33, wherein the specified type of data communications comprises at least broadcast and multi-cast data.

37. A method of managing subscriber connections between at least two types of wireless networks, comprising:
a first base station of a first type of wireless network communicating with a subscriber;
a second base station of a second type of wireless network communicating with the subscriber;
the subscriber maintaining communication with the first base station of the first type of wireless network for at least one specified type of data communication, and the subscriber simultaneously maintaining communication with the second base station of the second type of wireless network for at least one other specified type of data communication.
